(19) United States
(12) Patent Application Publication
(10) Pub. No.: US 2026/0087523 A1
(43) Pub. Date: Mar. 26, 2026

(54) Automated Advertisement Pushing System and Method

(71) Applicant: FUNLIDAY INC., Taipei (TW)

(72) Inventors: Weili HUANG, TAIPEI (TW); Mu Chun WANG, TAIPEI (TW); Hsing Chun TSAI, TAIPEI (TW); Chien Hsun LAI, TAIPEI (TW)

(21) Appl. No.: 18/891,810

(22) Filed: Sep. 20, 2024

(51) Int. Cl. G06Q 30/0251

(52) U.S. Cl. CPC G06Q 30/0271; G06Q 30/0256

(57) ABSTRACT

The present invention discloses an automated advertisement pushing system and method that obtain browsing behavior data of a user computer, determine one travel-related stage of a travel project relating to the user computer, select an advertising content based on the determined stage and push the advertising content to the user computer.

### TECHNICAL FIELD

The present invention relates to an automated advertisement pushing system and an automated advertisement pushing method, in particular to a system and method for automatically determining and placing on user computer advertisements for products and services based on the user's behavior in the planning and the implementation of a travel project using the user computer.

### BACKGROUND OF THE INVENTION

Automatically determining and placing advertisements for products and services based on consumers' browsing behavior have proven to be an effective way to improve the accuracy of advertising and save advertising costs. Various systems, devices and methods have been proposed in the industry.

Patent document CN116595248A discloses a method and device for pushing data objects. The method includes: obtaining second characteristics of a user and second characteristics of a data object based on the interactive relationship information between the user and the data object, using first characteristics of the user and first characteristics of the data object; calculating a similarity between the two second characteristics; adjusting the second characteristic of the target user and then calculating the similarity between the two second characteristics. Recommend data objects are determined based on the obtained similarity value.

U.S. Pat. No. 10,609,433B2 discloses a recommendation information pushing method, server, and storage medium. The method includes: obtaining a meta-path connecting a candidate user and a target user in a heterogeneous information network; based on the attribute value of the connection between the candidate user and the candidate recommended object, the attribute value constraints of the meta-path and the user similarity, modifying the attribute value of the connection between the candidate recommendation object and the target user; and sending recommendation information to the target user based on the calculated attribute value. This invention determines whether to push advertisements based on the target user's social relationship and the quantified relationship between the target user and candidate recommended object.

US20040054572A1 discloses a collaborative filtering method. The invention provides a method of filtering data to predict observations about items under specific circumstances. A method of filtering data to predict an observation about an item for a particular case is provided in which: a set of data representing actual observations about a plurality of items for a plurality of different cases is modelled as a function of a plurality of case and item profiles, each profile being a set of parameters comprising at least one hidden metrical variable, the parameters defining characteristics of the respective case or item; a best fit of the function to the data is found in order to find the values of the item profiles; and the profiles found are used together with the function to predict an observation for a particular case about one or more items for which data is not available for that case.

CN106503022B proposes a method and device for pushing recommended information. The method includes: obtaining a meta-path connecting a candidate user and a target user in a heterogeneous information network; the meta-path includes a connection with an attribute value between the candidate user and a candidate recommendation object; obtaining the target user and the candidate The user similarity of the user relative to the meta-path; estimating the candidate recommendation object and the target based on the attribute value of the connection between the candidate user and the candidate recommendation object, the attribute value constraints of the meta-path, and the user similarity The attribute value of the connection between users; when the estimated attribute value meets the recommendation condition, the recommendation information of the candidate recommendation object is sent to the terminal corresponding to the target user.

US20060294084A1 discloses methods and apparatus for a statistical system for targeting advertisements. The invention examines user profiles based on knowledge associated with the user. Check the content context profile associated with the application type and application environment. Examine ad profiles associated with multiple ads that contain multiple attributes. Finally, at least one preferred advertisement is selected from the plurality of advertisements based on statistical analysis of the user profile, the advertisement profile and the content context profile.

US20040260600A1 discloses a system and method for predicting demand for items. The invention is based on observing the behavior of trendsetters within a group of members, such as an online community, to determine and identify demand for items. This trendsetter is determined by studying the historical adoption behavior of a group within the membership group.

U.S. Pat. No. 9,986,277B2 discloses systems and methods to select targeted advertising. The method includes the steps of: identifying an advertisement corresponding to a first product; identifying a saturation measure for the advertisement; determining a net effect measure based on an opportunity measure based on the household's expected consumption of the first product and the saturation measure and the household's actual consumption of the first product; and when the net effect measure is greater than a threshold, delivering the advertisement to the household via media transmission.

US20160019625A discloses a method of determination of a purchase recommendation. The method includes receiving information indicative of product candidate attributes corresponding to a customer store classification that includes a group of customer stores. Relative in-category sales quantities are determined for each customer store category within the group of customer store categories, resulting in a set of quadrant representations, each quadrant representation representing a customer store category within the group of customer store categories. The steps are followed by determining purchase recommendations for the customer's store category based on the quadrant representation of the customer's store category.

US20110185384A1 discloses a system and method for targeted advertisements for video content delivery. The invention receives video content metadata from a content provider, matches the video content metadata with advertising content metadata to provide a first advertising list, determines a second advertising list based on user preference data, and sends the second advertising list to user equipment to insert into video content.

US20100100416A1 discloses a recommendation system for predicting project-related user behaviors that users will perform to recommend projects to users. The memory stores the data structure of the bilinear collaborative filtering model that specifies user behavior. Apply an automated inference operate to the data structure to predict user behavior given information about the user and information about the project. This user information includes user characteristics and unique user identification.

US20090157439A1 provides a system and method for travel related commercial interactions. This method conducts travel-related business interactions through aggregation systems such as websites. The aggregation system may be a social network, such as a social networking website.

US20080255935A1 discloses a temporal targeting of advertisements. Content, such as ads, can be pushed based on time of day, day of year, season, or upcoming holidays. Previous search history can be used to determine the current popularity and/or predict future popularity of specific concepts available for promotion.

WO2015143777A1 provides a pushing method and system for classifying and matching advertisement based on human face identification. The disclosed method includes: pre-categorizing advertisements according to suitable objects corresponding to the age and gender characteristics of different groups of people; generating a suitable advertising push list corresponding to the age and gender characteristics of different groups of people; when the smart terminal is required to perform advertisement push, using the face recognition technology of the face to identify the face of the current user, and obtaining and confirming the current user's age and gender characteristics, based on which, appropriate advertising push from the pre-generated advertising push list is selected.

US20100086107A1 proposes an advertising method based on voice recognition. The system operates voice communications in real time, performs speech recognition, and enters the advertising system based on the keyword combinations identified in the recognized speech and other target items (such as the user's past behavior) to retrieve information from the server such as advertisements, the user's physical location, etc. Finally, the selected advertisement is displayed to the user on the display of the user device.

U.S. Pat. No. 9,501,784B2 discloses a location-specific advertising method. Calculate ad relevance based on location information. It can also be used for attribute (for example, location) determination. Location information can be associated with price information, such as maximum bid, preferably associated with ad performance information. Ad performance information can be tracked based on location information, which may also be used to select and/or modify ad creative and/or landing page content.

US20080133336A1 provides a location-based advertising message serving for mobile communication devices. The invention is executed on a server computer coupled to multiple mobile communication devices via a wireless network. The geographical location of the mobile communication device operated by the user in the area is determined and displayed on the graphical interface of the mobile communication device. Advertising platform administrators provide advertisers with tools to select and deliver relevant advertising messages to users based on their specific location, time, and profile data.

US20110066497A1 proposes a personalized advertising and recommendation mechanism for recommending items to users. The method includes maintaining a database including user-related information, each piece of information at least including a history of user activities associated with a first entity related to an inventory of recommendable items; obtaining a database that is different from the first entity and different from the service provide information about the identity of the user who interacted with the second entity; associating the identity of the user who interacted with the second entity with a corresponding user profile; based on a history of user activity associated with the first entity, selecting a first set of items from the inventory for presentation to the user; forming specifications of the selected first set of items for presentation to the user during the user's interaction with the second entity.

From the above description of the existing technology, it can be seen that in order to improve the accuracy of advertising placement, the industry currently uses every possible means to detect, filter, and organize various user information, for use in selecting contents of advertising that shall be provided to the respectively corresponding users, whereby, the advertising content that the system determines to be most suited is pushed to specific user computers at specific times to improve advertising effectiveness and save advertising costs.

### Objectives of the Invention

The objective of the present invention is to provide a novel automated advertising pushing device and method.

Different from the previous technology that only selects advertising contents based on the user's personal data or attribute data, location information, social activity information, the user's previous online behavior, purchasing behavior, etc., this invention introduces a novel mechanism that selects advertising contents to be pushed, according to the stage of a travel project that the user is in.

According to the automated advertisement pushing method of the present invention, the system first obtains the browsing behavior data of a user computer, then determines a travel-related stage (of stages of a travel project) to which user of the user computer is in, based on the browsing behavior data, followed by determining a content to be provided to the user computer based on the determination result. The content may be posted in the webpage shown on the user computer, for the user to browse and/or operate. In a preferred embodiment of the present invention, the method may further include the steps of obtaining personal information corresponding to the user computer, and modifying the determination result of the content to be provided, according to the personal information.

The automated advertisement pushing method of the present invention can be executed or implemented in an advertising server that has a travel-related article database and an advertising contents database (advertising database), and can provide web pages for users to browse the travel-related articles and other contents. In such embodiments, the step of obtaining the browsing behavior data of the use computer may comprise obtaining the behavior data of the user computer when connecting to the advertising server and browsing the web page.

According to a preferred embodiment of the present invention, a travel-related stage may be a phase of development in a specific travel project or a general travel project. In this embodiment, the travel-related stages useful in the present invention may include: discovering, planning, get-ready, traveling, and sharing. The present invention provides a mechanism for detecting the travel-related stage a specific user is in, to achieve correct determination in the stage.

In addition, in a preferred embodiment of the present invention, the method may also comprise the steps of detecting a travel-related trend of a specific user, and modifying the determination results of the content to be provided, based on the trend so detected. In a preferred embodiment of the present invention, the travel-related trend may be a tendance in any aspect, such as countries, cities, seasons, etc., all for a travel project.

The contents to be provided to the user computers may be advertising information, especially promotional information for travel-related products and services. In this embodiment, the method may also comprise the steps of detecting a behavior of the user computer in clicking on a specific advertisement, and providing a product/service offering webpage based on the detection result, to the user computer for browsing and/or operation.

The present invention also provides a novel automated advertisement pushing system. The invented system can be built into a server computer and can be connected to or by a plurality of computer devices for the computer devices to access data stored in the server computer. The automated advertisement pushing system comprises:
an information collection device to collect information relating to a user when using a user computer to accesses data from the server compute; the information comprising the user computer's behavioral data;
a stage determination device to determine at least one travel-related stage based on the information obtained by the information collection device;
a pushing contents selection device to select at least one content to be provided to the user computer according to the determination result of the stage determination device; and
a pushing device to obtain the selected at least one content from an advertising database and providing the selected content to the user computer. The content may relate to the product/service to be promoted, preferably advertising content.

The content to be pushed corresponds to the travel related stage determined by the stage determination device 20. In a preferred embodiment of this invention, the pushing contents selection device selects the content by first selecting at least one product/service to be promoted from items of products/services stored in the advertising database, followed by selecting a content relating to the selected product/service from advertising contents stored in the advertising database.

In a preferred embodiment of the present invention, the information collection device may be configured to obtain personal information of a user, and the stage determination device may be configured to modified the determination result according to the user personal information obtained by the information collection device. This personal information may also be used to assist in selecting the product/service promotion information to be pushed, as well as in modifying the selection of the advertising contents.

In a preferred embodiment of the present invention, the automated advertisement pushing system further comprises a trend detection device for detecting at least one trend based on the behavior of the user computer. The trend may be one of the followings: target countries, cities and travel seasons that specific users tend to travel to/in.

The information collection device may further be configured to detect a behavior of the user computer in clicking on a specific advertisement. The pushing device may further be configured to provide product and/or service offering information based on the detection result, for the user computer to browse and/or operate.

The above and other objectives and advantages of the present invention will be more clearly understood from the following detailed description with reference to the accompanying drawings.

### BRIEF DESCRIPTION OF THE DRAWINGS

FIG. 1 shows the system block diagram of an embodiment of the automated advertisement pushing system of the present invention.

FIG. 2 is the flow chart of an embodiment of the automated advertisement pushing method of the present invention.

### DETAILED DESCRIPTION OF THE INVENTION

The automated advertisement pushing system and method of the present invention will be described below using examples, which shall not be used to limit the scope of this invention.

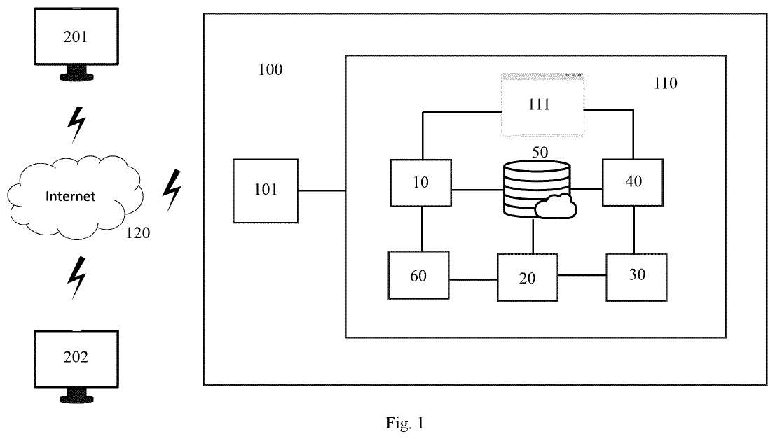

FIG. 1 shows the system block diagram of an embodiment of the automated advertisement pushing system 110 of the present invention. The preferred embodiment of the automated advertisement pushing system 110 shown in the figure is in the form of a computer module and is built in a server computer 100. The server 100 has a network communication module 101 and can be connected to the Internet 120 to receive data from user computer devices 201 and 202 and transmit data to specific or unspecific user computer devices 201 and 202. In a preferred embodiment, the automated advertisement pushing system 110 also provides a web page 111 for the user computer devices 201 and 202 to link, to brows and operate related web page functions. The automated advertisement pushing system 110 provides a web page 111, detects behavior data of the user computers 201 and 202, when they are browsing and/or operating the web page, selects advertisements or other contents to be pushed to the user computers 201 and 202 based on the behavior data behavior data and obtains the selected advertisements or contents from an advertising database 50, and places/displays them to the user computers 201 and 202 for display on their display in the webpage 111.

As shown in the embodiment of FIG. 1, the automated advertisement pushing system 110 according to the present invention comprises the following devices:

An information collection device 10 to provide a web page 111 that can be accessed for browsing and/or operation by the remotely connected user computers 201, 202 and to collect related information of a user, when the user uses one of the user computers 201 and 202 to connect the server computer 100 for access of the webpage. In a preferred embodiment of the present invention, the information may be the user computer's behavior data, especially behavior data representing the user computer's browsing activities in the Internet and/or operating activity on the web page functions. In this embodiment, the behavior data specifically refers to the behavior data relating to displaying certain contents of the web page 111 on the display of the user computer 201, 202 and/or operating the functions provided by the web page 111. The behavioral data may be information that represents or marks the behavior.

A stage determination device 20 to determine at least one travel-related stage based on the information obtained by the information collection device 10. In a preferred embodiment of the present invention, a travel-related stage may be a phase relative to an implementation day or scheduled implementation day of a single or multiple travels, including collective human activities relating to the travel(s).

A pushing contents selection device 30 configured to determine at least one advertising content to be pushed to the user computer 201, 202, according to the determination result of the stage determination device 20. The content to be promoted corresponds to the travel related stage determined by the stage determination device 20.

In a preferred embodiment of this invention, the pushing contents selection device selects the content by first selecting at least one product/service to be promoted from items of products/services stored in the advertising database, followed by selecting a content relating to the selected product/service from advertising contents stored in the advertising database, both corresponding to the travel related stage determined by the stage determination device 20. And

A pushing device 40 configured to obtain from an adverting database 50 at least one content item corresponding to the product/service selected by the pushing contents selection device 30 and provide the content to the one user computer. The content may be promotional information corresponding to the selected product/service. In a preferred embodiment of the present invention, the content has a corresponding relationship with the at least one travel-related stage. In a preferred embodiment, the content is transmitted to the user computer 201, 202 in digital form and displayed on the web page 111 provided by the information collection device 10 on the display of the user computer 201, 202. That is, the web page 111 currently displayed on the display, which web page is related or corresponding to the web page from where the information collection device 10 collects the user-related information.

In an automated advertisement pushing system 110 with the above technical features, the web page where the user behavior data is collected may be any web page displaying contents related to specific topics. There is no restriction on the form of the content and the content may comprise graphics, images, articles, audio, animations, continuous images, etc., and any combination thereof. Although there are no technical restrictions on the theme of the content, it is preferably a travel-related theme, or at least the content mentions/displays travel-related topics. The invention is beneficial when serving as an automated advertisement pushing system for travel-related advertisements. Although empirically, there is no restriction that a travel-related stage cannot be determined when the user is browsing topics irrelative to travelling, it can be presumed that determine the stage that the user is in, according to the user computer's browsing behavior on travel-related topics would generate a higher accuracy.

In a preferred embodiment of the present invention, the web page content is preferably stored in a designated sector in the advertising database 50, such as a travel-related article sector, or a separate travel-related article database. In the sector or the travel-related article database a number of travel-related articles are stored and updated. In order for the information collection device 10 to collect behavior data, each item of web page content is attached with a plurality of tags or indices to describe the characteristics or stage-related features of the web page content. This tag/index can indicate a specific web page content, or a part of a specific web page content, such as a certain paragraph or text of an article. This tag/index can usually be marked manually, but it can also be automatically marked using computer artificial intelligence technology, which is known to the skilled person. The nowadays AI technology can automatically mark tags/indices on articles, with a high accuracy sufficient for the application of the present invention.

In a preferred embodiment of the present invention, tags that can be used to describe the characteristics of travel-related articles may include: Child friendly, lovers, friendship, solo traveler, fine food, recommended by influencer, pet-friendly, self-driving, outdoors, motorcycling, coffee shop, literary youth, dessert, railway travel, night view, animals, skiing, hot springs, family, check-in attractions, IG attractions, city tour, makeups, cosmeceuticals, fashion, history, historic sites, museums, seaside, snorkeling, diving, vacation, mountain climbing, camping, dating, plan B for rainy day, shopping, IG spots, IG food, resort hotels, Michelin recommendations, photography, honeymoon trip, surfing, islands, graduation travel, theme parks, festivals/celebrations, natural landscapes, national parks, flower viewing, shrines, temples, art museums, river tracing, exhibitions, cultural experiences, adventure excitement, bicycles, bars, etc. These and other tags are useful in the determination of travel related stages, point of interests, trends, recommend products/services, selection of advertisements, etc.

In addition to the contents stored in the advertising database 50, contents that can be accessed through a network link or can be accessed online can also be used as the web content of the present invention. In most applications of the present invention, it is when the user computer browses a webpage 111 provided by the information collection device 10, calls the link function and inputs the URL through various known methods, does the information collection device 10 collect the user behavior data from the webpage. The information collection device 10 can then link to the URL and obtain the requested contents. The contents are displayed on the web page 111, or the user computer 201, 202 which is connected to the web address, wherein the web page 111 includes the web page of the requested web address. In this embodiment, the information collection device 10 is preferably equipped with an artificial intelligence application for automatically tagging/indexing, so as to generate useful tags within less than a second or within a few seconds. Since the relevant technology is already known, details thereof are thus omitted.

In an information collection device 10 with the above features, when the user computers 201 and 202 connect to the server computer 100 through the network to access data, the information collection device 10 responds to the request of the user computers 201 and 202, by providing a web page 111 and displaying requested contents in the web page 111. The contents can be in a variety of forms, as mentioned above. The web page 111 can be displayed by the user computers 201 and 202 connected to the automated advertisement pushing system 110 for browsing and/or operation. In a preferred embodiment of the present invention, the information collection device 10 collects relevant information of the user during the browsing period, including the user's behavior data, especially browsing behavior data, and activity information in operating the functions of the web page. In a preferred embodiment of the present invention, the behavioral information particularly includes at least one of the tags/indices attached to the web page contents, and/or the interaction record between the mouse of the user computer 201, 202 and the web page contents. In the following description, the information collected by the information collection device 10 will be called “stage determination information.”

As mentioned above, the stage determination device 20 is configured to determine at least one travel-related stage based on the stage determination data obtained by the information collection device 10. A travel-related stage is usually a period of time indicating a relationship between the user of the user computer 201 and 202 and a number of specific activities relating to a travel project. In particular, it refers to a phase relative to an implementation day or scheduled implementation day of a single or multiple travels, including collective human activities relating to the travel(s) of the user of the user computers 201, 202. There are no particular standards or conditions on the segmentation of the stages. However, in the embodiments of the present invention, there may be 5 travel related stages. They are: discovering, planning, get-ready, traveling, and sharing. However, other numbers of stages and/or other segmentation methods can also be applied to the present invention. In particular, the main purpose of segmenting the human activities, i.e., activities related to specific travel(s), according to their relationship with the specific travel(s), is to facilitate the pushing of correct advertising and the sale of related products and services. In other words, although the present invention does not need to be limited by a specific theory, in this invention when a specific person establishes a corresponding relationship with a specific travel related stage, advertisements for products or services corresponding to that stage are promoted to the specific person. It is easier to have that specific person to buy than advertising products/services that are not segmented by stage. The inventor also found that based on the user's behavior in browsing and operating web pages with travel-related contents, the travel related stage of the user can be substantially accurately determined.

According to a preferred embodiment of the present invention, the segmentation of the travel related stages can be rough, and the cut-off line between adjacent stages does not need to have clear boundaries, as long as the results of the segmentation can roughly form a corresponding relationship between stages and advertisements for different groups of products/services.

In such embodiments, the definition of the travel related stages may include:

| Travel related stage | General definition |
|---|---|
| Discovering | Intention to travel but undecided on destination |
| Planning | Destination and time are decided |
| Get-ready | A period of time before the trip, in which period the |
| | details of the itinerary are relatively clear. |
| Traveling | During travel |
| Sharing | A period after travel |

The above segmentation of the travel related stages is not any technical limitation. For example, the planning stage may be divided into a general planning stage and a detailed planning stage, if necessary. Conversely, the discovering stage and the planning stage can be combined into one stage, if necessary. The only requirement is results of the stage segmentation are useful to group the corresponding products/services to achieve the purpose of correct advertising.

In terms of determination in the travel related stage to which a user is in, the present invention provides the technology of judging the travel related stage to which a user belongs based on the user's behavioral information. In a preferred embodiment of the present invention, plural groups of featural travel related behavior can be used to make a correct or approximately correct determination. Useful features in such embodiments may include the following:

| Stage | Features | |
|---|---|---|
| Discovering | 1. | The behavior of browsing travel-related articles. |
| | 2. | The behavior of browsing relevant introductions of |
| | | attractions recommended in travel-related articles, provided, |
| | | however, that it is not possible to detect a trend, such as the |
| | | trend of a destination country/city based on the content |
| | | browsed, or that the browsed content cannot establish an |
| | | itinerary defined by a series of connected destinations. |
| | 3. | The behavior of searching for information related to tourist |
| | | attractions, provided, however, that it is not possible to detect |
| | | a trend, such as the trend of a destination country/city based |
| | | on the content browsed, or that the searched content cannot |
| | | establish an itinerary defined by a series of connected |
| | | destinations. |
| | 4. | The behavior of collecting tourist attractions, provided, |
| | | however, that it is not possible to detect a trend, such as the |
| | | trend of a destination country/city based on the content |
| | | browsed, or that the collected content cannot establish an |
| | | itinerary defined by a series of connected destinations. |
| Planning | 1. | The behavior of browsing travel-related articles, whereby |
| | | it is possible to determine a trend based on the content |
| | | browsed, such as the trend of a destination country/city. |
| | 2. | The behavior of browsing tourist attractions, whereby it is |
| | | possible to determine a trend based on the content |
| | | browsed, such as the trend of a destination country/city. |
| | 3. | The behavior of searching for tourist attractions, whereby |
| | | it is possible to determine a trend based on the tourist |
| | | attractions searched, such as the trend of a destination |
| | | country/city. |
| | 4. | The behavior of collecting tourist attractions, whereby it is |
| | | possible to determine a trend based on the tourist |
| | | attractions collected, such as the trend of a destination |
| | | country/city. |
| | 5. | The act of establishing an itinerary. |
| | 6. | The act of adding new tourist attractions to a specific |
| | | itinerary. |
| | 7. | The act of ordering tickets/the act of ordering a destination |
| | | experience itinerary. |
| Get-ready | | A certain number of days before travel, such as 3 days. However, |
| | | the number of days can be a variable and can vary according to the |
| | | tag attributes of different cities, seasons and travelers. |
| Traveling | | The period of a specific travel. |
| Sharing | | A certain number of days after the end of a specific travel period. |

In terms of determining the travel related stage, in a preferred embodiment of the present invention, the determination can be made based on, for example, the content of the web pages browsed and/or run by the user, especially based on the tags attached to the web pages browsed and/or operated by the user, such as clicking on a specific tag on the web page. However, other methods that are sufficient for the system to detect the user's web browsing behavior and/or operation behavior can be applied to the present invention. In the above preferred embodiments of the present invention:

1. The behavior of browsing travel-related articles can be detected by at least the following method: the web content provided on the platform provided by the information collection device 10 can all be presumed as “travel-related articles.” In other words, the webpage contents stored in the advertising database 50 for display on the webpage 111 usually includes various travel articles, which may include travel notes written by users and travel articles written by editors. In addition, the so-called “travel-related articles” are not limited to works described solely in text, but may also include or only include graphics, images, articles, audio, animations, continuous images, etc., and any combination thereof. These articles are tagged manually or automatically by computer, and their feature is assigned as “travel-related articles.” After the user browses on one article, or the user stays on the article page for more than a certain period of time, the system logs will be automatically recorded. This can be used to define the user's browsing behavior of travel-related articles. In addition, some operators provide tools for the public to plan their itinerary on online platforms. The browsing behavior before using these tools to enter itinerary planning can also be defined as the browsing behavior of travel-related articles. The information that the information collection device 10 collects includes information useful in judging the user's travel related stage, as well as the names of attractions that the user may be interested in.

2. Here, the term “tourist attractions” mainly refers to the name of places that tourists are interested in visiting. The geographical area referred to by the place name may be a large area or a point. The name of a tourist attraction may be one given by the attraction manager or the convention of the general public. In a preferred embodiment of the present invention, attraction tags can also be added to travel-related articles accessible on the platform provided by the information collection device 10. the information collection device 10 collects the behavior data of users when browsing related introductions to attractions recommended in travel-related articles in the manner described above. In other preferred embodiments, a web portal for travel-related articles introducing tourist attractions is provided on the platform, to provide attraction exploration functions at the portal to visit the attractions. After clicking, the user can see highlights of recommended attractions and search attractions in various places in the world. In addition, Taiwan Patent Publication No. 202403656 “Interactive itinerary planning system for embedding in web pages and operation method thereof” provides a method for automatically identifying attraction names in web articles. The method includes storing a plurality of names of tourist attractions in an attraction database; parsing a travel-related article to obtain words and matching the words in the attraction database to obtain at least one name of tourist attractions. This method can also be applied in the present invention. When a user clicks on an attraction name in an article, or when a user stays on an article page that displays a specific attraction name for more than a predetermined period of time, the system logs will automatically record this behavior. This can be used to detect the user's browsing behavior of the tourist attraction names.

3. The term “trend” referred to in the present invention pertains to the phenomenon of a specific user planning a travel project toward specific targets. After a certain amount of interaction between the user and the travel-related article webpage, the system may determine that a trend is formed. One preferred embodiment of the present invention uses the information collection device 10 to continuously detect, calculate and generate results in a dynamic manner. In a preferred embodiment of the present invention, the trends to be detected by the system include three major items: “country”, “city” and “season”. However, targets of other nature can also be used as a trend, and the information collection device 10 can be configured to determine whether a trend has been formed. In applications, for example, when a user browses an article, there are country tags or city tags attached to the article being detected. When the number of searches, browsing, favorites, clicks, etc. for/on articles, attractions, etc. exceeds the respective threshold, it can be determined that trends such as countries, cities, seasons, etc. have been formed. As for the threshold, it can be determined based on needs and/or experience. As long as the number of detection results is enough to reflect that a specific target already exists, it can be used as a threshold value to form a trend. For example, statistics show that users planning a trip to Tokyo will read n1 articles tagged with Tokyo and checkup n2 tourist attractions tagged with Tokyo on average before creating a trip project. These n values will be a useful variable related to Tokyo. This variable will have different values depending on different city combinations or seasons. This value may also change over time.

4. In terms of determining the travel related stage, the preferred embodiment of the present invention in most cases at first determines the start date and time, as well as the end date and time, of a specific travel project based on the related user's travel-related behavior data that represent, such as, booking tickets, purchasing tickets, booking hotels, renting cars, buying phone cards, etc. In a preferred embodiment of the present invention, the platform provided by the information collection device 10 also provides a transaction platform that accepts users to purchase various travel-related products and services. Users' booking, transaction, refund and other transactions on the platform can be detected and used to determine the start and end time of a single trip.

In order to effectively determine trends, in a preferred embodiment of the present invention, the automated advertisement pushing system may further comprise a trend detection device 60 for determining at least one trend based on the behavior data of the user computer. As mentioned before, the trend may be one of target countries, cities, and travel seasons that a specific user tends to travel to/in.

In a preferred embodiment of the present invention, the information collection device 10 can also be configured to obtain at least one item of user personal information. The personal information may be the personal information provided by the users via the user computers 201 and 202 when browsing an opinion survey or response page, as well as contained in the records of past browsing behavior of the users and may include tags. It may also be the personal information obtained using artificial intelligence technology, such as address, nationality, gender, frequently used language, browsing time slot, age range, income, education level, etc., useful in judging the stage of a travel project. The above-mentioned manual determination methods are also well known in the industry. Details thereof will be omitted.

In such embodiments, the stage determination device 20 is additionally configured to modify its determination result in the travel related stage based on the user personal information obtained by the information collection device 10 and corresponding to the user. For example, known possible travel periods and travel destinations may be used to modify the determination of travel related stages. The following examples illustrate this modification.

Example 1: In the detected article browsing behavior, the user has read travel related articles about cities such as Tokyo, Bangkok, and Seoul, but the number of tags for related events is not enough to form a trend, yet. If it is detected at this time that the user is 18-25 years old living in Taiwan and has a boyfriend or girlfriend, the system can then modify the determination to a trend of “traveling to Tokyo,” without waiting for more tags, because past statistical analyses have shown mem and women with such background information tend to travel to Japan, not Thai or Korea.

Example 2: The user is in the discovering stage and has read travel related articles about cities including Tokyo, Bangkok, and Okinawa, but the number of tags for related events is not enough to form a trend, yet. However, if the system detects that the user is a family member with children and has lived in both Hong Kong and Taiwan for longer than a predetermined time, the system will modify the determination to a trend of “traveling to Okinawa,” without waiting for more tags, because past statistical analyses have shown this trend. The system may at the same time determine the likelihood of renting a car to be high, because of the user's attribute of “family travel.”

Example 3: The system learned that the user had been searching for and collecting tourist attractions information from May to June, but the distribution of tourist attractions was relatively scattered, and their travel destinations could not be inferred to, yet. However, if the system determines that the user's attribute is “family travel,” it would determine that the user has a higher probability of traveling during the summer vacation.

The above examples show that users' personal information and past browsing records can indeed assist in determining the travel related stages as well as detecting a trend. Especially in the destination city, location, and possible travel season, the personal information benefits advancing a firm determination. After being modified by the above methods, the determination of the travel related stage can be more correct. Of course, other methods that can be used to modify and optimize the determination results can also be applied in the present invention.

The stage determination device 20 uses the information collected by the information collection device 10 to determine the travel related stage of the specific users via the above method and generates a determination result. Thereafter, the pushing contents selection device 30 determines at least one product/service to be promoted to the corresponding user computer 201, 202 based on the determination result of the stage determination device 20. In a preferred embodiment of the present invention, various products and services related or unrelated to travel are formed into groups, with each group corresponding to a travel-related stage. After the stage determination device 20 determines the travel related stage of a specific user, the pushing contents selection device 30 selects at least one product or service from the group in a predetermined priority order and selects in the advertising database 50 an advertising content corresponding to the selected product or service. The priority order may be determined in any rule, which may be a random order, an order according to the profit rate or discount rate of a product/service, quantity of stock, etc. Thereafter, the pushing contents selection device 30 further selects at least one content, in particular advertising content, from the contents stored in the adverting database 50 for providing to the user computer 201, 202. Similarly, a priority order may be set to a group of advertising contents corresponding to the selected product/service and/or the determined stage. In general, the priority order would be a rotation order, while in most cases there would be only one advertising content ready for pushing per one selected product/service.

After the content to be pushed is selected, the pushing device 40 obtains the selected content from the adverting database 50 and pushes the advertising content to the corresponding user computer for displaying on the web page that the user is browsing. If the user has left this webpage, the pushing device 40 finds the user's email address, mobile phone number, and/or social software account in the advertising database 50, and pushes the advertising content to the user through text messages or other applicable forms.

In the preferred embodiments of the present invention, there is no restriction on the method of grouping products and services according to travel related stages. However, products or services that are closely related to a specific travel related stage are usually attributed to that travel related stage. The table below shows one possible grouping method of products/services. However, the grouping rules of the present invention is not limited to this example:

| Stage | Products/Services to be promoted | |
|---|---|---|
| Discovering | 1. | Flight ticket. |
| | 2. | Hotel. |
| | 3. | Flight and hotel package. |
| | 4. | Travel-related financial products, such as credit cards. |
| Planning | 1. | Car rental, chartered car, airport shuttle. |
| | 2. | Event schedule/tickets. |
| | 3. | Discount coupons. |
| | 4. | Purchase of products from e-commerce (buy in advance and mail to |
| | | the hotel). |
| Get-ready | 1. | Travel safety insurance. |
| | 2. | Wi-Fi card/Wi-Fi machine. |
| Traveling | 1. | Transportation (mainly taxis). |
| | 2. | Discount coupons. |
| | 3. | Restaurant discounts near the user's current location. |
| | 4. | Same day activities near the user's current location. |
| Sharing | 1. | Write & share articles (including manufacturer sponsorship for users |
| | | to publish articles). |
| | 2. | Cross-border e-commerce products (for destinations that have been |
| | | visited). |

As mentioned above, there is no particular restrictions for selecting products and/or services to be promoted by the pushing contents selection device 30. However, in some preferred embodiments of the present invention, the pushing contents selection device 30 can randomly select the products/services to be promoted, or it can also select according to predetermined priority orders, for example, according to the price in the order of from high to low. In addition, the supplier can also be recommended with priority rule based on the geographical relationship of the supplier and the user. In a preferred embodiment of the present invention, the pushing contents selection device 30 is also configured to determine whether the user has already owned/purchased a specific product/service and excludes the hit from the list of recommendations.

The personal information as mentioned above can also assist the pushing contents selection device 30 in selecting products/services to be promoted and to modify the selection of recommended products. For example, when the system is aware of the annual income of a specific user or the amount spent on travel each year by the user, it can select products/services to promote or modify its selections based on this information.

In addition to being attached to the travel-related articles, the aforementioned tags can also be attached to cookies of specific users to assist in product/service recommendation and advertisement selection. Such tags can provide a very useful reference when selecting a product/service to promote. For example, after a specific user browses the article “Self-driving tour in southern Okinawa,” the system will attach tags such as “Self-driving,” “Outdoor,” “Island” etc. to the user's person information. Subsequent product recommendations will be pushed to the user with suitable selections. The system may provide a social media platform with a travel group function. When someone is invited to join a group and browses articles with the “parent-child” tag, the someone will be tagged with “parent-child” and “family” tags for further use.

After the products/services to be promoted are selected by the pushing contents selection device 30, the pushing device 40 selects at least one item related to the products/services from the advertising database 50 based on the determination result of the pushing contents selection device 30. The item is preferably an advertising content relating to a selected product/service. The pushing device 40 then pushes the selected advertising content to the user computer 201, 202. In a preferred embodiment of the present invention, the advertisement is transmitted to the user computer 201, 202 in digital form and displayed on the selected web page on the display of the user computer 201, 202. That is, displayed on the currently displayed web page that is related or corresponding to the web page from where the information collection device 10 collected the user-related information. As mentioned above, if the user has left the web page 111, the advertisement can also be pushed in the form of a text message.

In preferred embodiments of the present invention, the adverting content comprises interactive tools (not shown). After the user clicks or reacts in other operations, this interactive tool can generate transaction tools such as a transaction link or a purchase link to accept the user's purchase of specific products/services. This method of promotion, interaction, and transaction has become a common commercial application in the industry. The details are thus omitted.

There is no restriction on the method by which the pushing contents selection device 30 selects advertising contents. In most applications the advertising content is related to the products/services selected by the pushing contents selection device 30. In a preferred embodiment of the present invention, the advertising database 50 is provided with a plurality of advertising contents for specific products/services. The pushing contents selection device 30 may further use the personal information to assist in selecting advertising content to be pushed, or to modify the selection of advertising content.

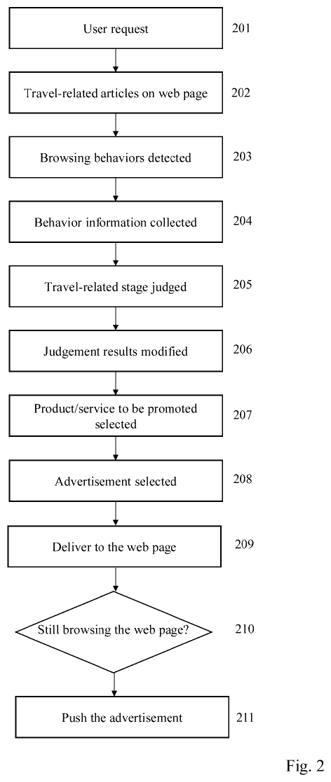

As mentioned above, the present invention also provides an automated advertisement pushing method. FIG. 2 is a flow chart showing an embodiment of the automated advertisement pushing method of the present invention. As shown in the figure, the method comprises the following steps: In step 201, the user connects to the system via the user computer 201, 202 and requests to browse travel-related articles. In step 202, the information collection device 10 provides a web page 111 and provides travel-related articles on the web page. In step 203, the information collection device 10 collects the user's behavior of browsing the travel-related article or operating the web page 111. In step 204, the information collection device 10 provides the collected information to the stage determination device 20.

In step 205, the stage determination device 20 determines a travel related stage of the user based on the received information. This travel related stage may be one of the following five stages: Discovering, planning, get-ready, traveling, and sharing after the trip. In step 206, the stage determination device 20 optionally modifies the determination result of the travel related stage based on personal information related to the user. In step 207, the pushing contents selection device 30 selects at least one product/service to be promoted based on the determination result. In this step, the pushing contents selection device 30 may additionally and optionally modify the selection result of the product/service to be promoted based on the personal information. In step 208, the pushing contents selection device 30 further selects at least one product/service advertising content in the advertising database 50 and in step 209, the pushing device 40 obtains the selected content from the adverting database 50 and delivers it to the web page 111.

The method of the present invention may also include the steps of determining whether the user has left the web page 111 in step 210, and pushing the product/service advertisement in the form of a text message to the user's mobile phone, email address or social media account in step 211.

### Effects of the Invention

The present invention discloses a technology for automatically distinguishing travel related stages and placing advertisements according to the travel related stage relating to a specific user. The experimental results show a click-through rate of as high as more than 20% (the denominator is number of unique users). In terms of the purchase rate of actual shopping guides, the experimental results found that the user purchase rate can reach up to 5%, which is a ratio difficult for ordinary e-commerce platforms to achieve.

What is claimed is:

1. An automated advertisement pushing method, to be executed by a server computer comprising a travel-related article database and an advertising database and providing webpages for browsing the travel-related articles; the method comprising the following steps:
collecting information relating to a user when the user computer accesses data from the server compute; the information comprising the user computer's behavioral data;
determining at least one travel-related stage based on the collected information;
selecting from the advertising database a content to be pushed to the user computer based on the determination result of the travel-related stage; and
providing the content to the user computer for the user to brows and/or operate.

2. The method according to claim 1, further comprising obtaining personal information relating to the user corresponding to the user computer and modifying the determination result in the travel-related stage according to the person information.

3. The method according to claim 1, further comprising obtaining personal information relating to the user corresponding to the user computer and modifying the selecting result in the content to be pushed to the user.

4. The method according to claim 1, wherein the travel related stage comprises a phase of development of a travel project.

5. The method according to claim 1, wherein the travel-related stage comprises one of the following stages: Discovering, planning, get-ready, traveling, and sharing.

6. The method according to claim 1, further comprising the steps of detecting a travel-related trend and modifying the selecting result in the content to be pushed according to the detected trend.

7. The method according to claim 6, wherein the travel-related trend comprises specific tendencies including a destination country, a destination city, or a travel season.

8. The method according to claim 1, wherein the behavior data comprises behavior data of browsing travel articles.

9. The method according to claim 8, wherein the behavior data comprises at least one tag attached to contents of the web page, and/or an interaction record between a mouse of the user computer and the web page.

10. The method according to claim 1, wherein the content pushed to the user computer comprises advertising for travel-related products and services.

11. The method according to claim 10, further comprising the following steps:
detecting a behavior of the user computer in clicking on a specific advertisement, and providing a product/service transaction webpage in response to the detection, for the user computer to browse and/or operate.

12. The method according to claim 1, wherein the content pushed to the user computer corresponds to the travel related stage.

13. The method according to claim 12, further comprising the following steps:
detecting a behavior of the user computer in clicking on a specific advertisement, and providing a product/service transaction webpage in response to the detection, for the user computer to browse and/or operate.

14. The method according to claim 1, wherein the selection of a content comprises the steps of selecting at least one product/service to be promoted from items of products/services stored in the advertising database, followed by selecting a content relating to the selected product/service from advertising contents stored in the advertising database.

15. The method according to claim 14 wherein the content to be pushed corresponds to the determined travel related stage.

16. An automated advertisement pushing system, to be embedded in a server computer for access of data therein by a plurality of computer devices; the automated advertisement pushing system comprising:
an information collection device to collect information relating to a user when the user computer accesses data from the server computer; wherein the information comprising the user computer's behavioral data;
a stage determination device to determine at least one travel-related stage based on the information obtained by the information collection device;
a pushing contents selection device to select at least one content to be pushed to the user computer according to the determination result of the stage determination device; and
a pushing device to obtain the selected content from an advertising database and provide the selected content to the user computer.

17. The system according to claim 16, wherein the information collection device is further configured to obtain personal information of a user, and the stage determination device is further configured to modified the determination result according to the user personal information obtained by the information collection device.

18. The system according to claim 16, wherein the information collection device is further configured to obtain personal information of a user, and the pushing contents selection device is further configured to modified the selected result according to the user personal information obtained by the information collection device.

19. The system according to claim 16, further comprising a trend detection device for detecting at least one travel-related trend based on the behavior data of the user computer.

20. The system according to claim 19, wherein the trend comprises a tendance selected from the group consisted of a destination country, a destination city and a travel season that specific users tend to travel to/in.

21. The system according to claim 16, wherein the user computer's behavioral data comprise browsing behavior data.

22. The system according to claim 21, wherein the browsing behavior data comprise behavior data of browsing travel-related articles.

23. The system according to claim 21, wherein the browsing behavior data comprise at least one tag attached to the webpage of the travel-related article, and/or an interaction record between a mouse of the user computer and the webpage content.

24. The system according to claim 16, wherein the pushed content comprises product/service recommendation information, and the product/service is related to the determined travel related stage.

25. The system according to claim 24, wherein the pushed content is selected by selecting at least one product/service to be promoted from items of products/services stored in the advertising database, followed by selecting a content relating to the selected product/service from advertising contents stored in the advertising database.

26. The system according to claim 24, wherein the pushed content comprises a purchase link to a page for travel-related products/services for the user computer to be redirected.

27. The system according to claim 16, wherein the information collection device is further configured to detect a behavior of the user computer in clicking on a specific advertisement and the stage determination device is further configured to provide product and/or service transaction information based on the detection result, for the user computer to browse and/or operate.

28. The system according to claim 16, wherein the travel-related stage comprises a phase of development of a travel project.

29. The system according to claim 28, wherein the travel-related stage comprises one selected from the group consisted of: Discovering, planning, get-ready, traveling, and sharing.

30. The system according to claim 28, wherein the pushed content comprises product/service recommendation information, and the product/service is related to the determined travel related stage.

31. The system according to claim 28, wherein the pushed content comprises purchase links for travel-related products and services for the user computer to be redirected.
